(19) United States
(12) Patent Application Publication
(10) Pub. No.: US 2014/0177831 A1
(43) Pub. Date: Jun. 26, 2014

(54) KEY PROTECTING METHOD AND A COMPUTING APPARATUS

(71) Applicant: Hung-Chien Chou, Taichung City (TW)

(72) Inventor: Hung-Chien Chou, Taichung City (TW)

(21) Appl. No.: 14/190,041

(22) Filed: Feb. 25, 2014

Related U.S. Application Data
(63) Continuation-in-part of application No. 13/559,504, filed on Jul. 26, 2012, now abandoned.
Application No. 13/559,504 is a continuation of application No. 12/565,688, filed on Sep. 23, 2009, now abandoned.

(30) Foreign Application Priority Data
Sep. 24, 2008 (TW) 097136673

(51) Int. Cl. H04L 9/08

(52) U.S. Cl. CPC H04L 9/0861
USPC 380/44

(57) ABSTRACT

A key protecting method includes the steps of: in response to receipt of an access request, configuring a control application program to generate a key confirmation request; in response to receipt of the key confirmation request, configuring a key protecting device to generate a key input request to prompt a user for a key input; upon receipt of the key input, the key protecting device determining if the key input matches a predefined key preset therein; the key protecting device entering an execution mode if it is determined that the key input matches the predefined key; and the key protecting device entering a failure mode if it is determined that the key input does not match the predefined key.

### CROSS-REFERENCE TO RELATED APPLICATION

This application is a continuation-in-part (CIP) of U.S. patent application Ser. No. 13/559,504, entitled “KEY PROTECTING METHOD AND A COMPUTING APPARATUS,” filed on Jul. 26, 2012, and abandoned as of the filing date of this application.

### BACKGROUND OF THE INVENTION

1. Field of the Invention

The invention relates to a key protecting method.

2. Description of the Related Art

In the 21^{st} century, computers are widely used to perform various functions, such as word processing, database management, account management, etc. However, malicious software (also known as “malware”), such as Trojan horse, provides hackers unauthorized access to the computers attacked by the malware, thereby leaving personal information, log-in accounts, pins, keys, etc., unprotected against hackers.

A Trojan horse generally refers to a computer program that users are tempted to install believing it to perform a desirable function, but that, in fact, performs a malicious function in disguise. Unlike computer viruses, Trojan horses do not replicate themselves or contaminate other files, but have the characteristics of concealment, automatic execution, disguise, self-recovery, and file damaging and/or transferring abilities. When a computer is installed with a Trojan horse, operational information of the computer may be stolen, files in the computer may be destroyed or deleted, and the computer may even be remotely control led by hackers. Trojan horses may be classified according to the purpose they serve, including information collection, data destruction, infiltration, etc., which are achieved by means of remote access, packet interception, input data recording, data transferring, etc.

Consequently, how to effectively protect keys and pins from being stolen by hackers is a goal that those in the computer field are striving to achieve.

### SUMMARY OF THE INVENTION

Therefore, the object of the present invention is to provide a key protecting method that effectively protects keys from being accessed by an operating system of a host device.

According to one aspect of the present invention, there is provided a key protecting method to be performed in a computing system that includes a host device, a key protecting device and an input device. The host device includes an operating system and a display unit. The operating system is installed with a control application program. The key protecting device is an independent, stand-alone device, is connected between the host device and the input device, and includes a control unit, a key comparing unit and a processing unit. The key protecting method includes the steps of:

(a) generating a key confirmation request, by the control application program, in response to receipt of a first access request;

(b) generating a key input request, by the control unit of the key protecting device, in response to receipt of the key confirmation request, the key input request being to be transmitted to the host device and displayed on the display unit so as to prompt a user for a key input;

(c) transmitting, by the control unit of oho key protecting device, input status information to the control application program upon receipt of the key input via the input device, the input status information being to be processed for display on the display unit and including a string of predefined or random character(s) non-related to the key input, the string having a length that is identical to the number of character(s) contained in the key input;

(d) determining, by the key comparing unit of the key protecting device, if the key input matches a predefined key preset in the key protecting device;

(e) if it is determined in step (d) that the key input matches the predefined key, the key protecting device entering an execution mode to transmit the result determined in step (d) to the control application program and to permit transmission of a processing request from the control application program to the key protecting

device for execution by the processing unit of the key protecting device; and

(f) the key protecting device entering a failure mode it is determined in step (d) that the key input does not match the predefined key.

Another object of the present invention is to provide a key protecting device that effectively protects keys from being accessed by an operating system of a host device.

Accordingly, there is provided a computing system including a host device, an input device and a key protecting device.

The host device includes an operating system and a display unit. The operating system is installed with a control application program for receiving an access request and generating a key confirmation request in response to receipt of the access request.

The key protecting device is connected between the host device and the input device, is an independent, stand-alone device, and includes a control unit, a key comparing unit and a processing unit. The control unit is in communication with the control application program of the host device for receiving the key confirmation request therefrom, and generates, a key input request in response to receipt of the key confirmation request. The key input request is to be transmitted to the host device and displayed on the display unit of the host device so as to prompt a user for a key input. The control unit transmits input status information to the control application program upon receipt of the key input via the input device. The input status information is to be processed for display on the display unit and includes a string of predefined or random character(s) non-related to the key input. The string has a length in the key input. The key comparing unit is coupled to the control, unit, and determines, upon receipt of the key input by the user from the input device, if the key input matches a predefined key preset in the key protecting device. The processing unit is coupled to the control unit, and is capable of executing a processing request. The key protecting device enters an execution mode if it is determined by the key comparing unit that the key input matches the predefined key, so as to transmit the result determined by the key comparing unit to the control application program and to permit transmission of a processing request from the control application program to the key protecting device for execution by the processing unit of the key protecting device. The key protecting device enters a failure mode if it is determined by the key comparing unit that the key input does not match the predefined key.

The present invention achieves the intended object by the fact that the key is directly inputted via the input device to the key protecting device for confirmation, and that the control application program installed in the operating system is not aware of the key itself, such that the key is not accessible by malicious software possibly installed in the operating system of the host device.

### BRIEF DESCRIPTION OF THE DRAWINGS

Other features and advantages of the present invention will become apparent in the following detailed description of the preferred embodiment with reference to the accompanying drawings, of which:

FIG. 1 is a block diagram of a computing system according to the preferred embodiment of the present invention;

FIG. 2 is a flow chart of a key confirming procedure of a key protecting method according to the preferred embodiment of the present invention; and

FIG. 3 is a flow chart of a key altering procedure of the key protecting method according to the preferred embodiment of the present invention.

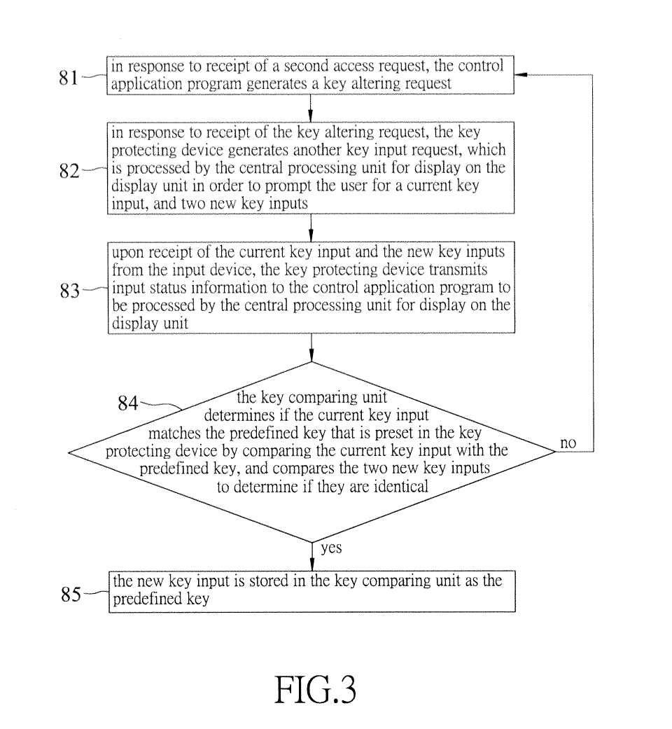

### DETAILED DESCRIPTION OF THE PREFERRED EMBODIMENT

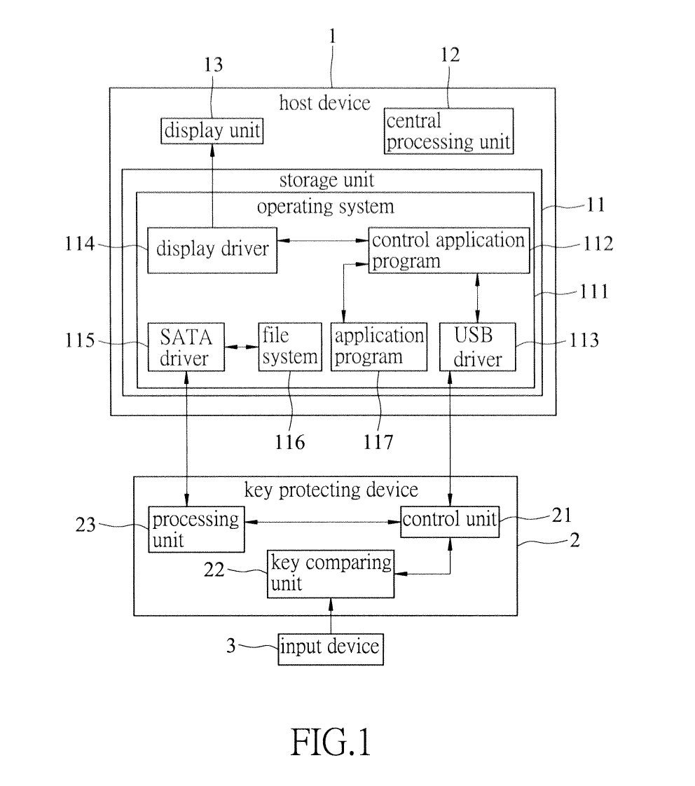

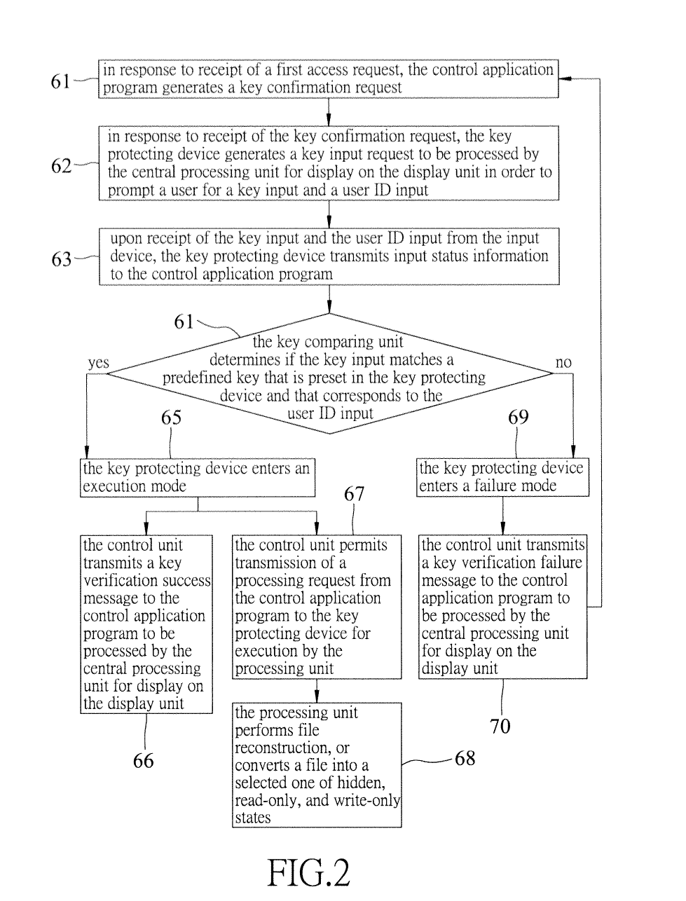

Referring to FIG. 1 and FIG. 2, according to the preferred embodiment of the present invention, a computing system for carrying out a key protecting method of this invention may execute a key confirming procedure and a key altering procedure, and includes a host device 1, a key protecting device 2 and an input device 3. The key protecting device 2 is a device that is connected between the host device 1 and the input device 3. The key protesting device 2 includes a control unit 21, a key comparing unit 22 and a procession unit 23. The host device 1 maybe a computer, and at least includes a storage unit 11, a central processing unit 12, and a display unit 13.

In this embodiment, the host device 1 has an operating system 111 stored in the storage unit 11 thereof, such as Windows®. The storage unit 11 may be a USB (universal serial bus) stick, a portable hard disk, a hard disk, or the like. The operating system 111 is installed with a control application program 112.

It should be noted herein that the key protecting device 2 is a product that can be sold on its own, separate from the host device 1, and may be packaged along with the control application program 112.

### Key Confirming Procedure

The key confirming procedure includes the following steps.

First, in step 61, in response to receipt of a first access request, which is entered through the input device 3 into the key protecting device 2 and forwarded to the control application program 112 by the key protecting device 2 or entered through user operation/command on the control, application program 112, the control application program 112 of the operating eye tern 111 generates a key confirmation request. It is noted herein that the control application program 112 serves as a bridge for communication between the host, device 1 and the key protecting device 2, that any input entered through the input device 3 must be monitored and intercepted by the key protection device 2 before being transmitted by the key protecting device 2 to the operating system 111 of the host device 1, and that the first access request is generated by a user input of a first hot key through the input device 3 in order to invoke the key protecting device 2 to transfer the first access request to the control application program 112. In this embodiment, the input device 3 may be a keyboard, and the first hot key may be a single key or a combination of keys inputted through the keyboard, such as P, ALT+P, CTRL+ALT+P, etc. The input device 3 may well be a mouse in other embodiments of this invention.

Next, in step 62, in response to receipt of the key confirmation request, the key protecting device 2 generates a key input request, which is processed by the central processing unit 12 for display on the display unit 13 in order to prompt the user for a key input, as well as a user ID input.

Subsequently, in step 63, upon receipt of the key input and the user ID input from the input device 3, the key protecting device 2 transmits input statue information to the control application program 112. The input status information is then processed by the central processing unit 12 for display on the display unit 13. The input status information may include a first string of predefined or random character(s) non-related to the key input, and a second string of character(s) identical to or irrelevant with the user ID input. The length of the first string is identical to the number of character(s) contained in the key input, and the length of the second string is identical to the number of character(s) contained in the user ID input. It is to be emphasized herein that the key input is not passed on by the key protecting device 2 to the host device 1, not even to the control application program 112 installed on the host device 1, such that the key input is only known by the key protecting device 2. Instead, the key protecting device 2 generates the “input status information” that is related to the key input only in the number of characters, and provides the same to the host device 1. For example, if the user enters “1234” as the key input through the input device 3, the key protecting device 2 does not transmit “1234” to the control application program 112 installed in the host device 1, but only transmits an input status information reflecting the number of characters in the key input, such as “****” or “&*%#”, to the control application program 112, such that the host device 1 is unaware of

the actual content of the key input.

Next, in step 64, the key comparing unit 22 of the key protecting device 2 determines if the key input matches a predefined key that is preset in the key protecting device 2 and that corresponds to the user ID input. In particular, the key comparing unit 22 of the key protecting device 2 compares the key input with the predefined key.

In this embodiment, the predefined key is pre-stored in key comparing unit 22 in practice, and can be added, altered, or deleted upon user instruction/command.

Then, in step 65, if it is determined in step 64 that the key input matches the predefined key, indicating

that the key input of the user is correct, the key

protecting device enters an execution mode and performs steps 66 to 68. Otherwise, the key protecting device enters a failure mode in step 69 and performs step 70, where the control unit 21 of the key protecting device 2 transmits a key verification failure message to the control application program 112 to be processed by the central processing unit 12 for display on the display unit 13.

In step 66, the control unit 21 of the key protecting device 2 transmits a key verification success message to the control application program 112 to be processed by the central processing unit 12 for display on the display unit 13.

In step 67, the control unit 21 of the key protecting device 2 permits transmission of a processing request from the control application program 112 to the key protecting device 2 for execution by the processing unit 23 of the key protecting device 2, such that, in this embodiment, in step 68, the processing unit 23 performs file reconstruction, or converts a the into a selected one of hidden, read-only, and write-only states.

To recap, during verification of the key by the key protecting device 2, any input entered through the input device 3 is blocked off from the host device 3. Once the key has been verified to be correct by the key protecting device 2, and the user wishes to perform, for example, word processing, on the host device 1 through the input decree 3, the inputs entered via the input device 3 are no longer blocked off from, but are passed on to the host device 1 by the key protecting device 2. In other words, the key protecting device 2, in cooperation with the control application program 112, determines when to prevent the inputs entered via the input device 3 from being accessed by the host device 1, and when to allow the host device 1 to gain access to the inputs entered via the input device 3, and serves as a guardian of the key, but does not hinder other input operations on the host device 1.

It should be noted herein that optionally, in order to prevent, for instance, dictionary attack, the key protecting device 2 may keep track of the number of times of entering the failure mode, and determines whether the number of times has reached a predetermined number (e.g., three), or alternatively, whether the number of times reaches a predetermined number within a predetermined time duration. If affirmative, the operations of the control application program 112 and the key protecting device 2 are terminated. In the negative, the flow goes back to step 62 to prompt the user again for a key input and a user ID input.

### Key Altering Procedure

The key altering procedure includes the following steps.

Firstly, in step 81, in response to receipt of a second access request, the control application program 112 of the operating system 111 generates a key altering request. It is noted herein that the second access request may be generated by a user input of a second hot key through the input device 3 or by user operation/command on the control application program 112 in order to invoke the key protecting device 2 to transfer the second access request to the control application program 112. In this embodiment, the input device 3 is a keyboard, and the second hot key may be a single key or a combination of keys inputted through the keyboard.

Next, in step 82, in response to receipt of the key altering request, the key protecting device 2 generates another key input request, which is processed by the central processing unit 12 for display on the display unit 13 in order to prompt the user for a current key input, two new key inputs, as well as a user ID input.

Subsequently, in step 83, upon receipt of the current key input, the new key input and the user ID input from the input device 3, the key protecting device 2 transmits input status information to the control application program 112. The input status information is then processed by the central processing unit 12 for display on the display unit 13. The input status information may include several strings of predefined or random character(s) non-related to the current/old key inputs and the user ID input.

It is again to be emphasized herein that the current key input, the new key inputs and the user ID input are not transmitted to the host device 1, including the control application program 112 installed therein, whereas the key protecting device 2 generates input status information related to the key inputs only in the number of characters for transmission to the control application program 112 so as to be displayed for viewing by the user.

Next, in step 84, the key comparing unit 22 of the key protecting device 2 determines if the current key input matches the predefined key that is preset in the key protecting device 2 and that cot responds to the user ID input, by comparing the current key input within the predefined key, and compares the two new key inputs to determine if they are identical.

Then, in step 85, if it is determined in step 84 that the current key input matches the predefined key, and that tee two new key inputs are identical, the new key input is stored in the key comparing unit 22 as the predefined key. Otherwise, the process returns to step 81.

A practical operational application is presented hereinbelow with reference to FIG. 1 to better illustrate the present invention. When a user wishes to convert a file into the hidden state, first of all, the user activates the control application program 112 installed in the operating system 1 by entering the first access request that is associated with a processing request related to the conversion of a file into the hidden state. Subsequently, the control application program 112 generates the key confirmation request and transmits the same to the control unit 21 of the key protecting device 2 via a USB (Universal Serial Bus) driver 113 installed on the operating system 111. Next, the control unit 21 generates the key input request to be displayed by the display unit 13 to prompt the user for the key input and the user ID input. After the user inputs the key input and the user ID input using the input device 1 that is in direct communication with the key comparing unit 22 and that is not in communication with the host device 1, the key comparing unit 22 compares the key input with the predefined key that corresponds to the user ID input, and informs the control unit 21 of true comparison result. If the comparison result indicates that the key input matches the predefined key, the control unit 21 transmits the key verification success message to the control application program 112 through the USB driver 113 to be displayed on the display unit 13 after being processed by a display driver 114 installed on the operating system 111. Then, the control unit 21 permits transmission of the processing request related to the conversion of a file into the hidden state from the control application program 112 to the key protecting device 2, and informs the processing unit 23 to execute the necessary subsequent processing. In this instance, the processing unit 23 conducts transactions with a file system 116 of the operating system ill via a SATA (Serial Advanced Technology Attachment) driver 115 for converting the selected file into the hidden state.

It should be noted herein that, in the above disclosure, it is assumed that the key protecting device

2 is connected to the host device 1 using a USB interface, thereby having the USB driver 113 serving as a communication bridge. However, in practice, the key protecting device 2 may communicate with the host device 1 using means other than a USB interface. Such variations should be readily apparent to those skilled in the art, and the disclosure herein should not be taken to limit the scope of the present invention.

Moreover, in an alternative embodiment, instead of transmitting the processing request to the key protecting device 2, alter verifying that the user's key input matches the predefined key, the control application program 112 is permitted by the key protecting device 2 to transmit a command to another application program 117 installed on the operating system 111 (such as a word processing application program), and permits the application program 117 to provide corresponding services (such as word processing abilities) to the user in order to perform intended operations.

In sum, the key protecting method of the present invention achieves the object of preventing a malicious entity from obtaining the predefined key by ensuring that the key input provided by the user is inputted only to the key comparing unit 22 of the key protecting device 2, and not to the host device 1, that the comparison of the key input and the predefined key is performed within the key protecting device 2, and that only the comparison result (match or does not match) is provided to the host device 1. Consequently, even if the host device 1 is attacked by a malware, the key necessary for performing certain functions is protected by the key protecting device 2 and will not be stolen by the malware.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements. What is claimed is:

1. A key protecting method to be per termed in a computing system that inclusion a host device, a key protecting device and an input device; the host device including an operating system and a display unit, the operating system being installed with a control application program, the key protecting device being an independent, stand-alone device, being connected between the host device and the input device and including a control unit, a key comparing unit and a processing unit, the key protecting method comprising the steps of:
(a) generating a key confirmation request, by the control application program, in response to receipt of a first access request;
(b) generating a key input request, by the control unit of the key protecting device, in response to receipt of the key confirmation request, the key input request being to be transmitted to the host device and displayed on the display unit so as to prompt a user for a key input;
(c) transmitting, by the control unit of the key protecting device, input status information to the control application program upon receipt of the key input via the input device, the input status information being to be processed for display on the display unit and including a string of predefined or random character(s) non-related to the key input;
(d) determining, by the key comparing unit of the key protecting device, if the key input matches a predefined key preset in the key protecting device;
(e) if it is determined in step (d) that the key input matches the predefined key, the key protecting device entering an execution mode to transmit the result determined in step (d) to the control application program and to permit transmission of a processing request from the control application program to the key protecting device for execution by the processing unit of the key protecting device; and
(f) the key protecting device entering a failure mode if it is determined in step (d) that the key input does not match the predefined key.

2. The key protecting method as claimed in claim 1, wherein in step (e), processing capabilities of the processing unit in the execution mode include file reconstruction, and converting a file into a selected one of hidden, read-only, and write-only states.

3. The key protecting method as claimed in claim 1, wherein, in step (f), the control unit transmits a key verification failure message to the control application program, and the flow goes back to step (a).

4. The key protecting method as claimed in claim 3, wherein, in step (f), the key protecting device keeps track of the number of times of entering the failure mode, and operations of the control application program and the key protecting device are terminated when the number of times reaches a predetermined number.

5. The key protecting method as claimed in claim 3, wherein, in step (f), the key protecting device keeps track of the number of times of entering the failure mode, and operations of the control application program and the key protecting device are terminated when the number of times reaches a predetermined number within a predetermined time duration.

6. The key protecting method as claimed in claim 1, wherein, in step (f), the control unit transmits a key verification failure message to the control application program, and operations of the control application program and the key protecting device are terminated.

7. The key protecting method as claimed in claim 1, wherein, in step (e), the control unit transmits a key verification success message to the control application program.

8. The key protecting method as claimed in claim 1, wherein communication between the control application program and the control unit is conducted via a Universal Serial Bus (USB) interface.

9. The key protecting method as claimed in claim 1, wherein in stop (a), the first access request, is generated by inputting a hot key through the input device.

10. The key protecting method as claimed in claim 1, wherein in step (b), the key input request further prompts the user for a user identification (ID) input, in step (c), the input status information further includes another string of predefined or random character(s) non-related to the user ID input, and in step (d), the key comparing unit of the key protecting device determines it the key input matches a predefined key preset in the key protecting device and corresponding to the user ID input.

11. The key protecting method as claimed in claim 1, further comprising the steps of:
(g) generating a key altering request, by the control application program, in response to receipt of a second access request;
(h) generating another key input request, by the control unit of the key protecting device, in response to receipt of the key altering request, said another key input request being to be transmitted to the host device and displayed on the display unit so as to prompt a user for a current key input and two new key inputs;
(i) transmitting, by the control unit of the key protecting device, input status information to the control application program upon receipt of the current and new key inputs, the input status information being to be processed for display on the display unit and including strings of predefined or random character(s) non-related to the current and new key inputs;
(j) determining, by the key comparing unit of the key protecting device, if the current key input matches the predefined key preset in the key protecting device, and whether the new key inputs are identical to each
(k) if it is determined in step (j) that the current key input matches the predefined key, and that the new key inputs are identical to each other, the key protecting device stores the new key input as the predefined key.

12. The key protecting method as claimed in claim 11, wherein in step (g), the second access request is generated by inputting a hot key through the input device.

13. A computing system comprising:
a host device including an operating system that is installed with a control application program for receiving an access request and generating a key confirmation request in response to receipt of the access request, and a display unit;
an input device; and
a key protecting device connected between said host device and said input device, being an independent, stand-alone device, and including
a control unit that is in communication with said control application program of said cost device for receiving the key confirmation request therefrom, and generating, a key input request in response to receipt of the key confirmation request, the key input request being to be transmitted to said host device and displayed on said display unit of said host device so as to prompt a user for a key input, said control unit transmitting input status information to said control application program upon receipt of the key input via said input device, the input status information being to be processed for display on the display unit and including a string of predefined or random character(s) non-related to the key input,
a key comparing unit that is coupled to said control unit, and that determines, upon receipt of the key input by the user from said input device, if the key input matches a predefined key preset in said key protecting device, and
a processing unit coupled to said control unit, and capable of executing a processing request; and
wherein said key protecting device enters an execution mode if it is determined by said key comparing unit, that the key input matches fee predefined key, so as to transmit, the result determined by said key comparing unit to said control application program and to permit transmission of a processing request from said control, application program to said key protecting device for execution by said processing unit of said key protecting device; and
wherein said key protecting device enters a failure mode if it is determined by said key comparing unit that the key input does not match the predefined key.

14. The computing system as claimed in claim 13, wherein processing capabilities of said processing unit, in the execution mode include file access, file reconstruction, and converting a file into a selected one of hidden, read-only, and write-only states.

15. The computing system as claimed in claim 13, wherein said control unit transmits a key verification failure message to said control application program to be displayed on said display device, and awaits another key confirmation request from said control application program when said key protecting device enters the failure mode.

16. The computing system as claimed in claim 13, wherein said cent sol unit transmits a key verification success message to said control application program for subsequent display on said display device when said key protecting device enters the execution mode.

17. The computing system as claimed in claim 13, wherein communication between said control application program and said, control unit of said key protecting device is conducted via a Universal Serial Bus (USB) interface.

18. The computing system as claimed in claim 13, wherein the access request is generated by inputting a hot key through said input device.

19. The computing system as claimed in claim 13, wherein the key input request further prompts the user for a user identification (ID) input, the input status information further includes another string of predefined or random character(s) non-related to the user ID input, and said key comparing unit of said key protecting device determines if the key input matches a predefined key preset in said key protecting device and corresponding to the user ID input.
